(19) United States
(12) Patent Application Publication
(10) Pub. No.: US 2009/0268378 A1
(43) Pub. Date: Oct. 29, 2009

(54) SOLID ELECTROLYTIC CAPACITOR AND METHOD OF MANUFACTURING THE SAME

(75) Inventors: Hiroyuki Matsuura, Shiga (JP); Tatsuji Aoyama, Yamaguchi (JP); Shigetaka Furusawa, Kyoto (JP); Yukiya Shimoyama, Yamaguchi (JP); Yuuki Murata, Yamaguchi (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/422,567

(22) Filed: Apr. 13, 2009

(30) Foreign Application Priority Data
Apr. 23, 2008 (JP) 2008-112350

(51) Int. Cl. H01G 9/02; H01G 9/07; H01G 9/15

(52) U.S. Cl. 361/524; 29/25.03

(57) ABSTRACT

A solid electrolytic capacitor has a capacitor element and a conductive polymer as a solid electrolyte. The capacitor element includes an anode foil having a dielectric oxide film thereon, a cathode foil, and a separator interposed between the anode and cathode foils, which are wound so as to form a capacitor element. The conductive polymer is disposed between the anode and cathode foils and formed by chemical polymerization of a polymerizable monomer. The separator is made of a nonwoven fabric of synthetic fiber and has an affinity to the polymerizable monomer. The separator includes main fibers and binder fibers each having a fiber diameter smaller than that of each of the main fibers and allowing the main fibers to be bonded together.

### BACKGROUND OF THE INVENTION

1. Field of the Invention

The present invention relates to a winding type solid electrolytic capacitor used for a variety of electronic devices and a method of manufacturing the same.

2. Background Art

According to the trend of using electronic devices in higher frequency, capacitors with large capacitances and low impedances in a high frequency range have been demanded. Recently, in order to reduce the impedance in a high frequency range, capacitors using a solid electrolyte such as a conductive polymer with high electric conductance have been studied. Furthermore, in order to increase capacitance, winding type solid electrolytic capacitors have been commercialized, which can achieve a structure with a larger capacitance more easily as compared with the case where electrode foils are laminated on each other. The solid electrolytic capacitor of this type has a configuration in which an anode foil and a cathode foil are wound with a separator interposed therebetween so as to form a capacitor element.

It is essential that a solid electrolytic capacitor having a winding structure includes a separator preventing an anode foil and a cathode foil from being in contact with each other. As the separator, carbonized electrolytic paper (hereinafter, referred to as “carbonized paper”) is used, which is obtained by forming a capacitor element by using electrolytic paper such as Manila hemp or kraft paper and then carbonizing the electrolytic paper by, for example, a heating method. That is to say, carbonized paper is formed by carbonizing a so-called electrolytic paper that is used in conventional electrolytic capacitors using an electrolytic solution as an electrolyte. Alternatively, as the separator, a glass fiber nonwoven fabric, a nonwoven fabric including dry melt-blown resin as a main component, and the like, are used.

Furthermore, it has been proposed that a nonwoven fabric mainly including synthetic fibers be used as a separator. For example, a nonwoven fabric in which synthetic fibers, that is, resins including polyvinyl alcohol as a base material (hereinafter, referred to as “vinylon”) are bonded with a binder, and a mixed nonwoven fabric obtained by mixing vinylon as a main component with other resin can be used. Furthermore, a nonwoven fabric of polyethylene terephthalate fibers (hereinafter, referred to as “PET fibers”) and the like can be used.

On the other hand, an example of the conductive polymer as a solid electrolyte includes polypyrrole, polythiophene, polyaniline, polyethylene dioxythiophene, and the like. By chemical oxidative polymerization with these polymerizable monomers and oxidizing agents, a conductive polymer can be formed.

As a method of forming a conductive polymer, a method including immersion into a mixed solution of a polymerizable monomer and an oxidizing agent, and drying and heating thereof; and a method of carrying out immersion into a polymerizable monomer solution and immersion into an oxidizing agent solution, separately, are known.

However, in a winding type solid electrolytic capacitor, it is necessary to heat at a temperature higher than 250° C. in order to carbonize electrolytic paper. With this heating, a dielectric oxide film is damaged and a leakage current is increased. Therefore, when carbonized paper is used as a separator, even if the damage is repaired by aging, an incidence of short circuit is increased. Furthermore, with this heating, a plating layer (for example, a tin/lead layer) of lead wires for leading-out of the solid electrolytic capacitor is oxidized. Therefore, in a usual plating wire, the solder wettability in the lead wire portion of a completed product is remarkably reduced. In order to respond this problem, expensive silver-plated lead wire having a strong oxidation resistant property must be used.

When a glass fiber nonwoven fabric is used for a separator, needle-like glass fibers may be scattered to the surrounding at the time of cutting or winding, which may cause a problem in terms of the working environment. Furthermore, the strength at the time of bending accompanying the winding is weak, so that a solid electrolytic capacitor may be short-circuited easily.

When a nonwoven fabric including resin as a main component is used as a separator, the tensile strength is weaker than that of electrolytic paper. Therefore, when a capacitor element is wound up, the separator may be cut easily. Consequently, the incidence of short circuit during aging is high. Furthermore, an adhesive component used at the time of adhesively bonding resin fibers to each other makes it difficult to allow the separator to hold the conductive polymer. Therefore, it is difficult to manufacture a solid electrolytic capacitor having low impedance in a high frequency range.

In particular, when a nonwoven fabric of vinylon is used, since vinylon has poor heat resistance, it is easily decomposed when a solid electrolytic capacitor is used at a high temperature or when high temperature reflow treatment is carried out at the time of soldering. When vinylon is decomposed, gas is generated and an internal pressure is increased. Therefore, a sealing portion may be damaged easily. Additionally, an electrical characteristic of a solid electrolytic capacitor may be easily damaged.

When a conductive polymer is formed in carbonized paper or the above-mentioned nonwoven fabric, a size per capacity becomes larger than the case where an electrolytic solution is used as an electrolyte. This is because exfoliation between the separator and the conductive polymer due to thermal stress and the like may cause the increase in the impedance or the reduction in the use rate of capacity.

Furthermore, when a conductive polymer is directly formed in a capacitor element in which a nonwoven fabric of vinylon is wound, a capacitance property cannot be obtained easily. Therefore, it is necessary to form a conductive polymer after a binder is dissolved and removed by previously immersing the capacitor element into water of 80 to 100° C. for 1 to 10 minutes. This treatment can provide a separator with the affinity of a solvent for an oxidizing agent. Thus, a conductive polymer can be formed without damaging the permeability of the polymerizable monomer and the oxidizing agent. However, because the binder is dissolved and removed unevenly, properties of the obtained solid electrolytic capacitor vary.

When a nonwoven fabric of PET fibers is used as a separator, the holding property of the capacitor element for the conductive polymer is improved as compared with the case where a nonwoven fabric of vinylon fibers is used for a separator. However, when the capacitor element is disassembled after the conductive polymer is formed, the conductive polymer is not formed in the center portion (the center in the width direction of winding) of the capacitor element. Therefore, the capacity of the entire capacitor element cannot be used.

### SUMMARY OF THE INVENTION

The present invention relates to a solid electrolytic capacitor having a large capacitance and being excellent in the impedance property and the leakage current property, and a method of manufacturing the same. The solid electrolytic capacitor of the present invention has a capacitor element and a conductive polymer as a solid electrolyte. The capacitor element is formed by winding an anode foil having a dielectric oxide film thereon and a cathode foil with a separator interposed between the anode foil and the cathode foil. The conductive polymer is disposed between the anode foil and the cathode foil and formed by chemical polymerization of a polymerizable monomer. The separator is a nonwoven fabric of synthetic fibers. The separator includes main fibers and binder fibers having a fiber diameter smaller than that of the main fiber and allows the main fibers to be bonded together. With such a configuration, the separator has an affinity to a polymerizable monomer. Therefore, a conductive polymer can be formed even in the center portion of the capacitor element.

Furthermore, a method of manufacturing this solid electrolytic capacitor includes following steps; forming a capacitor element; anodic-oxidizing the capacitor element with an aqueous solution of phosphate and heat treating thereof; and forming a conductive polymer. In the forming of the capacitor element, an anode foil having a dielectric oxide film and a cathode foil are wound with a separator made of a nonwoven fabric of synthetic fibers interposed therebetween. In the anodic-oxidizing of the capacitor element with an aqueous solution of phosphate and heat treating thereof, the dielectric oxide film of the anode foil is repaired and the affinity of the separator to a polymerizable monomer is improved. In the forming of the conductive polymer after heat treatment, the capacitor element is impregnated with the polymerizable monomer and an oxidizing agent so as to form the conductive polymer as a solid electrolyte between the anode foil and the cathode foil by chemical polymerization reaction. Then, the separator includes main fibers, and binder fibers having a fiber diameter smaller than that of the main fiber and allowing the main fibers to be bonded together. With this method, a dielectric oxide film can be formed on a defective portion and an end portion of a dielectric oxide film of the anode foil. Furthermore, a phosphate compound bonded to the surface of the main fiber and the binder fiber forming the separator is stabilized and an affinity to the polymerizable monomer solution can be improved. Furthermore, the configuration of the separator allows a polymerizable monomer solution to soak into the center portion of the capacitor element easily. As a result, a conductive polymer can be formed up to the center portion of the capacitor element.

### BRIEF DESCRIPTION OF THE DRAWINGS

FIG. 1 is a partial sectional perspective view showing a configuration of a solid electrolytic capacitor in accordance with the embodiment of the present invention.

FIG. 2 is an enlarged conceptual view showing a principal part of a capacitor element of the solid electrolytic capacitor shown in FIG. 1.

FIG. 3 shows an electron microscopy image of a separator used in the solid electrolytic capacitor shown in FIG. 1.

### DETAILED DESCRIPTION OF THE INVENTION

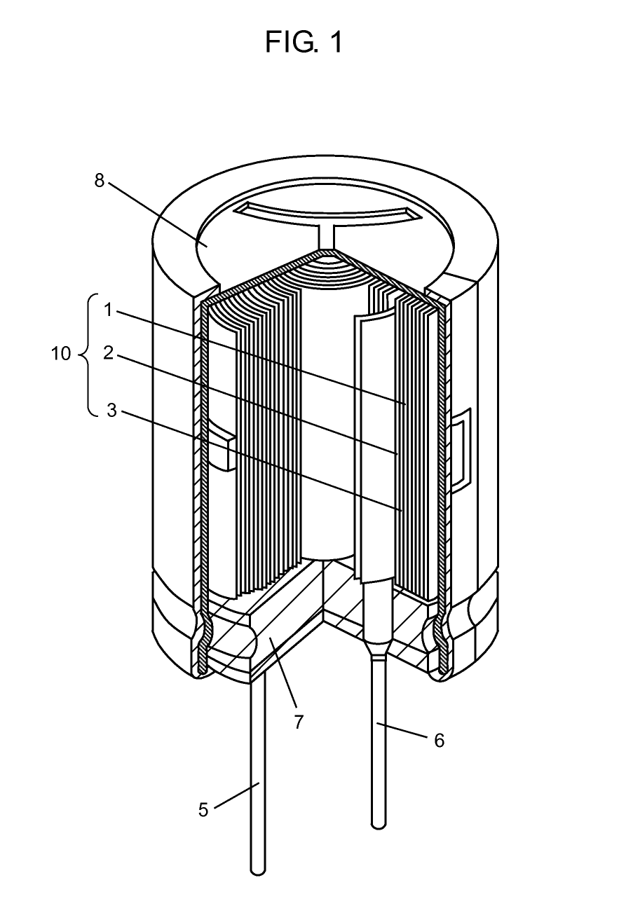

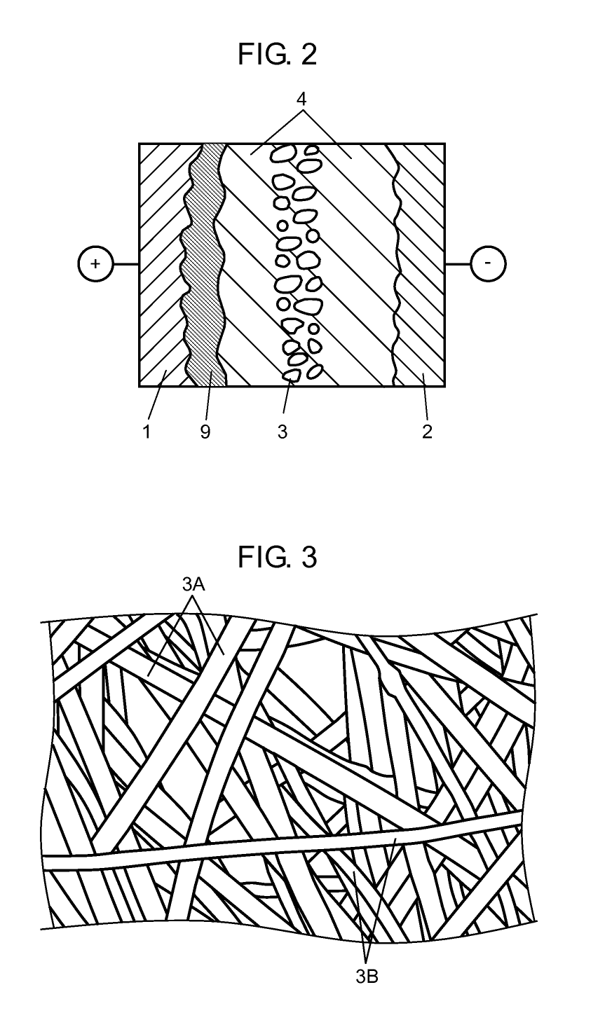

FIGS. 1 and 2 are a partial sectional perspective view showing a configuration of a solid electrolytic capacitor and an enlarged conceptual view showing a principal part of a capacitor element of the solid electrolytic capacitor, respectively. FIG. 3 shows an electron microscopy image of a separator used in the solid electrolytic capacitor.

This solid electrolytic capacitor includes capacitor element 10 and conductive polymer 4. Capacitor element 10 is formed by winding anode foil 1 having dielectric oxide film 9 thereon and cathode foil 2 with separator 3 interposed between anode foil 1 and cathode foil 2. Conductive polymer 4 is disposed between anode foil 1 and cathode foil 2 and formed by chemically polymerizing a polymerizable monomer. Separator 3 is made of a nonwoven fabric of synthetic fibers and has an affinity to a polymerizable monomer. As shown in FIG. 3, separator 3 includes main fibers 3A and binder fibers 3B having a fiber diameter smaller than that of main fiber 3A and allowing main fibers 3A to be bonded together.

For anode foil 1, an aluminum foil is used. Its surface is roughened by an etching process, and then dielectric oxide film 9 is formed by anodic oxidation treatment. Also for cathode foil 2, an aluminum foil is used and it is etched before forming capacitor element 10. Anode foil 1 and cathode foil 2 are wound up with separator 3 interposed therebetween so as to form capacitor element 10. Capacitor element 10 is subjected to anodic oxidation with an aqueous solution of phosphate and then heat treated. Furthermore, conductive polymer 4 is formed between wound-up anode foil 1 and cathode foil 2.

After conductive polymer 4 is formed in this way, capacitor element 10 is accommodated in aluminum case 8 having a cylindrical shape with a bottom. Then, an open end of aluminum case 8 is sealed with rubber sealing member 7. At this time, anode lead 5 and cathode lead 6 for external leads derived from anode foil 1 and cathode foil 2 respectively are allowed to penetrate into sealing member 7. Thus, a winding type solid electrolytic capacitor is formed.

As a solution for anodic-oxidizing capacitor element 10, phosphoric acid-based electrolytic solutions, boric acid-based electrolytic solutions and adipic acid-based electrolytic solutions can be used. An example of the phosphoric acid-based electrolytic solution includes ammonium dihydrogen phosphate and diammonium hydrogenphosphate. An example of the boric acid-based electrolytic solution includes ammonium borate. An example of the adipic acid-based electrolytic solution includes ammonium adipate. Among them, it is preferable that anodic oxidation treatment is carried out by using an aqueous solution of ammonium dihydrogen phosphate and setting the immersion time to 5 to 60 minutes. Thus, an electrolytic solution soaks into the center portion of capacitor element 10 and the hydrophobic properties of the surfaces of main fiber 3A and binder fiber 3B are increased, so that conductive polymer 4 is easily adhesive-bonded to anode foil 1 and cathode foil 2.

The thus anodic-oxidized capacitor element 10 is subjected to heat treatment. This heat treatment stabilizes dielectric oxide film 9 formed on anode foil 1. That is to say, even if a part of dielectric oxide film 9 is damaged due to handling such as winding, the damaged portion can be repaired. Furthermore, the heat treatment stabilizes a phosphate compound bonded to the surfaces of main fiber 3A and binder fiber 3B forming separator 3 so as to improve the affinity to the polymerizable monomer solution. Consequently, conductive polymer 4 can be formed up to the center portion of capacitor element 10. The heat treatment temperature is in the range of 125-200° C. When the temperature is out of this range, the degree of stabilization of dielectric oxide film 9 and the phosphate compound is reduced.

As conductive polymer 4, polypyrrole, polythiophene, polyaniline, polyethylene dioxythiophene, and the like, can be used. Conductive polymer 4 can be formed by chemically oxidizing a polymerizable monomer as a raw material with an oxidizing agent. As the oxidizing agent, iron salt such as benzenesulfonate, p-toluenesulfonate, and naphthalenesulfonate can be used. Among them, 3,4-ethylenedioxythiophene monomer (hereinafter, referred to as “EDT”) as a polymerizable monomer and ferric p-toluenesulfonate (hereinafter, referred to as “p-TS”) as an oxidizing agent are preferred. EDT is preferable to form conductive polymer 4 up to the center portion of capacitor element 10 because it is known that oxidative polymerization of EDT proceeds extremely slowly.

As the chemical oxidative polymerization, two methods can be employed; a method of carrying out chemical oxidative polymerization by using a mixed solution of a polymerizable monomer, an oxidizing agent and a solvent, and a method of carrying out immersion into a polymerizable monomer solution and immersion into an oxidizing agent solution, separately. Among them, it is preferable to employ the method of carrying out immersion into a polymerizable monomer solution and then immersion into an oxidizing agent solution. Such a method allows the polymerizable monomer to soak into the center portion of capacitor element 10 since the polymerizable monomer solution has an affinity to a material forming separator 3 of capacitor element 10. Thereafter, immersion into the oxidizing agent solution is carried out, thereby making chemical oxidative polymerization at the center portion to proceed easily.

As mentioned above, separator 3 includes main fibers 3A and binder fibers 3B, and the fiber diameter of binder fiber 3B is smaller than that of main fiber 3A. Thus, gaps between main fibers 3A can be easily maintained constantly and uniformly. As a result, the affinity of separator 3 to the polymerizable monomer solution is further improved. Consequently, the polymerizable monomer solution easily adapts to separator 3, and a polymerizable monomer solution soaks into the center portion of capacitor element 10. Thus, conductive polymer 4 can be formed uniformly. Therefore, it is possible to produce a solid electrolytic capacitor that is excellent in a low ESR property and a leakage current property.

Furthermore, it is preferable that the content of main fiber 3A is smaller than the content of binder fiber 3B. Thus, an effect of reducing the fiber diameter of binder fiber 3B is further exhibited. Namely, the polymerizable monomer solution easily soaks into the center portion of capacitor element 10 more easily, and conductive polymer 4 can be formed further uniformly.

Main fiber 3A forming separator 3 is formed of, for example, polyethylene terephthalate (PET), polyester, polyvinyl alcohol, polyimide, aramid, polyolefin, or the like. In particular, separator 3 in which main fiber 3A formed of a nonwoven fabric of PET fibers is preferable. The nonwoven fabric of PET fibers is preferable because it does not react with the oxidizing agent remaining after polymeric reaction of conductive polymer 4 or acid generated by decomposition of the oxidizing agent at high temperature.

Note here that binder fiber 3B includes synthetic fiber of PET, polyester, polyvinyl alcohol, polyimide, aramid, polyolefin, or the like. It is preferable that binder fiber 3B is made of a fiber having a lower softening temperature than that of main fiber 3A. Furthermore, when binder fiber 3B that is the same kind of material as main fiber 3A is used, a fiber having a lower softening temperature than that of main fiber 3A is selected by a processing method of fibers or mixture of fibers and the like.

It is preferable that the fiber diameter of main fiber 3A is not less than 5 μm and not more than 10 μm, and the fiber diameter of binder fiber 3B is not less than 3 μm and not more than 7 μm. When the fiber diameters are out of those ranges, the polymerizable monomer solution does not easily soak, so that conductive polymer 4 cannot be easily formed in the center portion of capacitor element 10.

Furthermore, the fiber length of main fiber 3A and binder fiber 3B is in the range of 3 to 8 mm. The fiber length is out of this range, as separator 3 for the solid electrolytic capacitor, the strength is lowered and a preferable thickness cannot be obtained.

When main fiber 3A is made of PET, a PET fiber containing diethylene glycol component as a copolymerized glycol component is preferable from the viewpoint of strength and heat resistance. When binder fiber 3B is also made of PET, a PET fiber containing a diethylene glycol component as a copolymerized glycol component and carboxybenzenesulfonic acid as a copolymerized acid component is preferable from the viewpoint of strength and heat resistance.

The thickness of separator 3 is in the range of 10-100 μm, and preferably 20-60 μm. When the thickness is smaller than this lower limit value, the withstand voltage is reduced. Furthermore, when the thickness is more than this upper limit value, it is difficult to miniaturize a capacitor.

Furthermore, the density of separator 3 is in the range of 0.1-1 g/cm³, and preferably 0.2-0.6 g/cm³. The basis weight is in the range of 10-30 g/m², and preferably 15-25 g/m². The values are smaller than the lower limit values, the strength and the withstand voltage are reduced. On the other hand, the values are more than the upper limit values, sufficient conductive polymer 4 is not formed in separator 3, thus deteriorating the electric property.

A nonwoven fabric obtained by a spunbond process or a wet process is preferable as separator 3. Separator 3 produced by each of these methods has extremely good adhesion and adhesiveness with respect to conductive polymer 4.

Next, specific Examples of this embodiment are described. The present invention is not limited to these.

A surface of an aluminum foil is roughened by an etching process, and then dielectric oxide film 9 is formed by anodic oxidation treatment (formation voltage is set at 8V) so as to form anode foil 1. On the other hand, am aluminum foil is subjected to an etching process so as to produce cathode foil 2. Then, they are wound with separator A obtained by a wet process shown in Table 1 interposed therebetween so as to produce capacitor element 10. Note here that capacitance in the frequency of 120 Hz when capacitor element 10 is impregnated with 10 wt. % ethylene glycol solution of ammonium adipate is 670 μF.

Next, capacitor element 10 is subjected to anodic oxidation (voltage is set at 8V) in 0.5 wt. % aqueous solution of ammonium dihydrogen phosphate, and then heat treated at 125° C. for 10 minutes.

Next, heat-treated capacitor element 10 is immersed in a solution containing 25 parts by weight of EDT as a heterocyclic monomer, 50 parts by weight of p-TS as an oxidizing agent and 100 parts by weight of n-butanol as a polymerization solvent, and lifted, thereafter stood still at 85° C. for 60 minutes. Thereby, chemical polymeric conductive polymer 4 as a solid electrolyte of polyethylene dioxythiophene is formed between anode foil 1 and cathode foil 2.

Thus, capacitor element 10 including conductive polymer 4 in this way is filled in aluminum case 8 having a cylindrical shape with a bottom together with sealing member 7 made of resin-vulcanized butyl rubber. Sealing member 7 includes 30 wt. % of butyl rubber polymer, 20 wt. % of carbon, and 50 wt. % of inorganic filler. The hardness is 70 IRHD (unit according to International Rubber Hardness Degree). Thereafter, an opening is sealed by curling process. Thus, a solid electrolytic capacitor having a diameter of 8 mm and height of 8 mm is produced. This solid electrolytic capacitor is defined as sample A.

Hereinafter, solid electrolytic capacitors of samples B to Y are produced by the same method as in sample A except that separators B to Y shown in Table 1 are used instead of using separator A. Note here that separators A to J are made of a PET nonwoven fabric by wet process.

On the other hand, separator X is made of a glass fiber nonwoven fabric having a thickness of 50 μm and basis weight of 15 g/m². Separator Y is a polyvinyl alcohol nonwoven fabric having a thickness of 40 μm and basis weight of 15 g/m² and formed by a melt-blow method.

Sample Z is produced as follows by the same way as in sample A excepted that separator Z shown in Table 1 instead of separator A is interposed and winding is carried out. Separator Z is electrolytic paper made of Manila hemp having a thickness of 45 μm. Then, solid electrolytic capacitor 10 is produced by the same method as in sample A except that capacitor element 10 is heated in nitrogen atmosphere at 275° C. for 2 hours to carbonize separator Z.

TABLE 1

| | | | | | | content of | thickness | |
|---|---|---|---|---|---|---|---|---|
| | | Main fiber | | Binder fiber | | main fiber/ | of | |
| | | fiber diameter | fiber length | fiber diameter | fiber length | binder resin | separator | basis weight |
| | Kind | (μm) | (mm) | (μm) | (mm) | (weight ratio) | (μm) | (g/m²) |
| separator A | PET nonwoven fabric | 5.0 | 4.0 | 3.0 | 4.0 | 40/60 | 40 | 15 |
| separator B | PET nonwoven fabric | 6.5 | 4.0 | 4.5 | 4.0 | 40/60 | 40 | 15 |
| separator C | PET nonwoven fabric | 8.5 | 4.0 | 6.0 | 4.0 | 40/60 | 40 | 15 |
| separator D | PET nonwoven fabric | 10.0 | 4.0 | 7.0 | 4.0 | 40/60 | 40 | 15 |
| separator E | PET nonwoven fabric | 12.0 | 4.0 | 7.0 | 4.0 | 40/60 | 40 | 15 |
| separator F | PET nonwoven fabric | 6.5 | 4.0 | 4.5 | 4.0 | 30/70 | 40 | 15 |
| separator G | PET nonwoven fabric | 6.5 | 4.0 | 4.5 | 4.0 | 50/50 | 40 | 15 |
| separator H | PET nonwoven fabric | 6.5 | 4.0 | 4.5 | 4.0 | 60/40 | 40 | 15 |
| separator J | PET nonwoven fabric | 5.0 | 4.0 | 7.0 | 4.0 | 40/60 | 40 | 15 |
| separator X | glass fiber nonwoven | 5.0 | 4.0 | 7.0 | 4.0 | 40/60 | 50 | 15 |
| | fabric | | | | | | | |
| separator Y | polyvinyl alcohol | 5.0 | 4.0 | 7.0 | 4.0 | 40/60 | 40 | 15 |
| | nonwoven fabric | | | | | | | |
| separator Z | Manila hemp | 5.0 | 4.0 | 7.0 | 4.0 | 40/60 | 45 | 15 |

The properties of the solid electrolytic capacitors of samples A to Z produced as mentioned above are evaluated and the measurement results are shown in Table 2. As the properties, capacitance at 120 Hz, impedance at 100 Hz, and leakage current are evaluated. As the leakage current, a value measured two minutes after a rated voltage of 6.3 V is applied is measured. These evaluations are carried out before and after the high temperature voltage application test. In the high temperature voltage application test, a voltage of 4 V is applied between anode lead 5 and cathode lead 6 at 105° C. and maintained the situation for 2000 hours.

The number of testing capacitors is 50 each. Table 2 shows average values thereof. Furthermore, the property values after the high temperature voltage application test are expressed by an average value of samples excluding short circuited products.

TABLE 2

| | | | | Value after high temperature voltage | | |
|---|---|---|---|---|---|---|
| | Initial value | | | application test | | |
| | capaci- | | leakage | capaci- | | leakage |
| | tance | ESR | current | tance | ESR | current |
| Sample | (μF) | (mΩ) | (μA) | (μF) | (mΩ) | (μA) |
| A | 652 | 4.7 | 6 | 619 | 5.3 | 2 |
| B | 657 | 4.5 | 5 | 625 | 5.1 | 1 |
| C | 660 | 4.7 | 7 | 628 | 5.3 | 4 |
| D | 662 | 4.9 | 9 | 630 | 5.3 | 8 |
| E | 665 | 5.0 | 11 | 632 | 5.0 | 14 |
| F | 669 | 4.5 | 3 | 635 | 4.9 | 3 |
| G | 650 | 5.2 | 8 | 617 | 5.6 | 4 |
| H | 640 | 5.5 | 15 | 579 | 6.1 | 22 |
| J | 620 | 6.1 | 10 | 566 | 6.6 | 24 |
| X | 555 | 10.5 | 69 | 452 | 31 | 221 |
| Y | 597 | 8.0 | 10 | 485 | 16 | 10 |
| Z | 620 | 6.0 | 15 | 450 | 15 | 123 |

In solid electrolytic capacitors of samples A to H, the fiber diameter of main fiber 3A is larger than that of binder fiber 3B in separator 3. On the other hand, in sample J, the fiber diameter of main fiber 3A is smaller than that of binder fiber 3B. Therefore, the capacitances of samples A to H are larger than the capacitance of sample J. This is thought to be because conductive polymer 4 is formed inside capacitor element 10 more uniformly in samples A to H than in sample J.

Furthermore, in samples A to D and samples F and G, the content of main fiber 3A is smaller than that of binder fiber 3B. On the other hand, in sample H, the content of main fiber 3A is larger than that of binder fiber 3B. In sample E, the fiber diameter of main fiber 3A is more than 10 μm. Therefore, conductive polymer 4 can be formed inside capacitor element 10 more uniformly in samples A to D and samples F and G than in samples H and E. As a result, the usage rate of the electrode foils is improved and the capacitance is increased as shown in Table 2. Furthermore, ESR can be reduced and in particular, and the LC (leak current) property becomes excellent.

Thus, it is preferable that the content of main fiber 3A is smaller than the content of binder fiber 3B, and it is preferable that the fiber diameter of main fiber 3A is not more than 10 μm. Furthermore, as is apparent from Tables 1 and 2, it is preferable that the fiber diameter of main fiber 3A is not less than 5 μm and not more than 10 μm and that the fiber diameter of binder fiber 3B is not less than 3 μm and not more than 7 μm.

Furthermore, since a nonwoven fabric obtained by a wet process is used for separator 3, the adhesion and adhesiveness between conductive polymer 4 as a solid electrolyte and separator 3 are extremely excellent. Therefore, as compared with the cases where separators made of other materials shown in samples X to Z, the impedance in the high frequency range is reduced.

Furthermore, polyethylene dioxythiophene and the like as conductive polymer 4 can be attached and adhesively bonded on separator 3 strongly. Therefore, the change in the impedance after the high temperature voltage application test is small, thus, the reliability is high as a surface mount type solid electrolytic capacitor that undergoes reflow treatment.

Furthermore, in the solid electrolytic capacitors of samples X to Z, it is confirmed that the occurrence rate of short-circuit during aging treatment due to the contact between the anode foil and the cathode foil caused by the shortage of the strength of the separator is high.

As mentioned above, the solid electrolytic capacitor of the present invention includes a capacitor element and a conductive polymer as a solid electrolyte. The capacitor element is formed by winding an anode foil having a dielectric oxide film thereon and a cathode foil with a separator interposed between the anode foil and the cathode foil. The conductive polymer is disposed between the anode foil and the cathode foil, and formed by chemically polymerizing a polymerizable monomer. The separator is made of a nonwoven fabric of synthetic fibers and has an affinity to a polymerizable monomer. The separator includes main fibers and binder fibers having a fiber diameter smaller than that of the main fiber and allowing main fibers to be bonded together.

With such a configuration, the affinity of the separator with respect to a polymerizable monomer solution is improved and the polymerizable monomer solution soaks easily. As a result, a polymerizable monomer solution soaks into the center portion of the capacitor element so as to form a conductive polymer uniformly. Therefore, a solid electrolytic capacitor excellent in a low ESR property and a leakage current property can be produced, providing a great industrial value.

What is claimed is:

1. A solid electrolytic capacitor, comprising:
a capacitor element including
an anode foil having a dielectric oxide film thereon,
a cathode foil, and
a separator made of a nonwoven fabric of synthetic fibers and interposed between the anode foil and the cathode foil,
wherein the capacitor element is formed by winding the anode foil, the cathode foil and the separator; and
a conductive polymer as a solid electrolyte disposed between the anode foil and the cathode foil and formed by chemical polymerization of a polymerizable monomer;
wherein the separator has an affinity to the polymerizable monomer and includes
main fibers, and
binder fibers each having a fiber diameter smaller than that of each of the main fibers and allowing the main fibers to be bonded together.

2. The solid electrolytic capacitor according to claim 1,
wherein the main fibers are made of polyethylene terephthalate.

3. The solid electrolytic capacitor according to claim 2,
wherein the binder fibers are made of polyethylene terephthalate having a lower softening temperature than that of the main fibers.

4. The solid electrolytic capacitor according to claim 1,
wherein a content of the main fibers is smaller than a content of the binder fibers.

5. The solid electrolytic capacitor according to claim 1,
wherein a fiber diameter of the main fibers is not less than 5 μm and not more than 10 μm, and a fiber diameter of the binder fibers is not less than 3 μm and not more than 7 μm.

6. A method of manufacturing a solid electrolytic capacitor, the method comprising:
winding an anode foil having a dielectric oxide film thereon and a cathode foil with a separator made of a nonwoven fabric of synthetic fibers interposed therebetween to form a capacitor element;
anodic-oxidizing the capacitor element with an aqueous solution of phosphate and heat treating thereof, thereby repairing the dielectric oxide film on the anode foil, and improving an affinity of the separator to a polymerizable monomer; and
after the heat treating, impregnating the capacitor element with the polymerizable monomer and an oxidizing agent, thereby forming a conductive polymer as a solid electrolyte between the anode foil and the cathode foil by a chemical polymerization reaction;
wherein the separator includes:
main fibers, and
binder fibers each having a fiber diameter smaller than that of each of the main fibers and allowing the main fibers to be bonded together.

7. The method of manufacturing a solid electrolytic capacitor according to claim 6,
wherein the main fibers are made of polyethylene terephthalate.

8. The method of manufacturing a solid electrolytic capacitor according to claim 7,
wherein the binder fibers are made of polyethylene terephthalate having a lower softening temperature than that of the main fibers.

9. The method of manufacturing a solid electrolytic capacitor according to claim 7,
wherein a content of the main fibers is smaller than a content of the binder fibers.

10. The method of manufacturing a solid electrolytic capacitor according to claim 6,
wherein a fiber diameter of the main fibers is not less than 5 μm and not more than 10 μm, and a fiber diameter of the binder fibers is not less than 3 μm and not more than 7 μm.
